(19) United States
(12) Patent Application Publication
(10) Pub. No.: US 2012/0259664 A1
(43) Pub. Date: Oct. 11, 2012

(54) COMPUTER PROGRAM, COMPUTER SYSTEM, AND COMPUTER-IMPLEMENTED METHOD FOR INCOME-PRODUCING PROPERTY INVESTMENTS

(75) Inventor: Timothy J. Malone, Valley Center, KS (US)

(73) Assignee: Pinnacle Consulting, L.L.C., Valley Center, KS (US)

(21) Appl. No.: 13/290,861

(22) Filed: Nov. 7, 2011

Related U.S. Application Data
(63) Continuation-in-part of application No. 13/082,607, filed on Apr. 8, 2011.

(51) Int. Cl. G06Q 40/08

(52) U.S. Cl. 705/4

(57) ABSTRACT

A computer program, computer system, and computer-implemented method for income-producing property investments. The computer program is stored on a computer-readable medium for directing operation of a computer system to assist with the purchase and management of an income-producing property investment. The computer program includes a code segment for receiving data related to the income-producing property; a code segment for receiving data related to a plurality of life insurance policies; and a code segment for identifying, at least partially based on the data related to the income-producing property, and the data related to the life insurance policies, life insurance policies that may be purchased and associated with the income-producing property to enhance an investment metric of the income-producing property.

### RELATED APPLICATION

The present U.S. non-provisional patent application is a continuation-in-part of earlier-filed U.S. non-provisional patent application titled “METHOD FOR INVESTOR ACQUISITION OF INCOME PRODUCING PROPERTY”; Ser. No. 13/082,607, filed Apr. 8, 2011. As such, the present application claims, with regard to all common subject matter, priority benefit of the identified earlier-filed application, and hereby incorporates by reference the earlier-filed application in its entirety.

### BACKGROUND

The present invention relates to property investment methods, processes, and practices. More particularly, embodiments of the invention relate to a computer program, computer system, and computer-implemented method for income-producing property investments.

Investors often purchase office buildings, apartment buildings and other tangible income-producing properties because they typically produce income and appreciate in value. To increase the rates of returns of such investments, investors often leverage the income-producing properties by obtaining loans for part or all of the purchase prices from banks or other lenders. In conventional lending methods, cash flow demands borne by the investor/borrower typically consist of the costs of debt service during the term of the purchase money loan and the costs of maintaining, insuring, and managing the income-producing properties which are acquired. Such cash flow demands are typically relieved only by the income stream produced by the purchased properties. The conventional terms of such loans are undesirably inflexible, hindering the lender's and investor's abilities to vary and relieve the cash flow demands directed against the investor and to vary and relieve the lender's exposure to loan default risks.

Accordingly, there is a need for an improved method of purchasing and financing income-producing property investments.

### SUMMARY

The present invention solves the above-described problems and provides a distinct advance in the field of income-producing property investments. Embodiments of the invention assist with the purchase and finance of income-producing properties by “bundling” a matched or tailored portfolio of life insurance policies with an income-producing property targeted for acquisition. A loan or loans may then be secured to finance the purchase of the income-producing property and/or the life insurance policies. By including life insurance policies within the assets purchased with the loan proceeds, cash flow demands borne by the property investor may be advantageously relieved during the term of the loan and/or the lender's risk of loss through default may be advantageously lessened while maintaining the lender's debt investment for the loan's term.

A method of the present invention may begin when an investor identifies one or more tangible income-producing properties to purchase and negotiates an asset purchase contract with the current owners of the properties. At least a portion of the negotiated purchase price (i.e., a first purchase price) may be funded with the proceeds of a loan from a lender. In other embodiments, the properties may be purchased with no loans. The title to the income-producing properties may be received directly by the investor, with the investor granting a mortgage, security interest, or trust deed to the lender.

In some embodiments of the invention, a lender protection trust or other trust may be established for the receipt of title to the income-producing properties and for holding such title during the acquisition financing period. As fiduciary holder of the income-producing properties, the trust receives and manages the income from the investment properties (a first income stream).

An owner or a group of owners of life insurance policies, brokers of such policies, and/or life insurance providers who are interested in selling their policies may then be identified. Owners of life insurance policies may enter into life settlement financial transactions when they no longer need the future security offered by the death benefits payable under the policies, or where such owners are no longer able to pay the periodic premiums needed to maintain the policies. The method of the present invention may access a database containing information about the life insurance policies, or a portfolio of such policies, to select which policies should be bundled with the income-producing properties as discussed below. A company such as a life expectancy actuarial provider, or other company specializing in actuarial analysis, may be engaged to analyze and give opinions of the life expectancies of the individual insureds listed among the portfolio of life insurance policies. Following actuarial analysis of the life expectancies of the insureds, a financial analysis is preferably performed to project the likely course of death benefit payments (i.e., a second income stream) which will be produced by the portfolio over time.

Data for the income-producing properties and the life insurance policy is then analyzed to identify which of the life insurance policies, or a portfolio of such policies, best enhance an investment metric of the income-producing property. A computer program described in the DETAILED DESCRIPTION section below may be used to assist with the selection of the life insurance policies.

A portfolio of the selected life insurance policies is then acquired. As with the purchased income-producing property, the ownership of the portfolio of life insurance policies may be placed directly with the investor with a security interest therein granted by the investor to the lender or, more desirably, the trust may act as the holder of the portfolio of life insurance policies. Lender loan proceeds, if any, pay as a second purchase price the acquisition cost of the portfolio of life insurance policies.

The terms of financing which are negotiated with the lender may take into account the expected course of death benefits payments of the life insurance policies so that such payments progressively decrease the principal balance of the loan over the life of the loan. Alternatively, the death benefits may be held in trust, resulting in progressive reductions of the lender's default risk exposure over the life of the loan. The maturity date of the investment property and insurance portfolio acquisition loan may be negotiated and set to occur on or after a projected date at which the portfolio of life insurance policies will produce death benefits cumulatively equaling the loan's principal balance.

Upon reaching the maturity date of the property acquisition loan, death benefits produced by the portfolio of life insurance policies typically will have satisfied and retired the loan. At that point in the life of the loan, security commitments to the lender, such as mortgages, security interests, and deeds of trust granted to the lender may be released, leaving the investor with clear and unencumbered ownership of the targeted income-producing properties, along with any remaining and outstanding life insurance policies within the policy portfolio.

In the event that some portion of the loan's principal balance remains outstanding upon the loan's maturity, a sufficient portion of the remaining portfolio of life insurance policies may be sold to retire the loan. Thereafter, clear title to the income-producing properties and any remaining portfolio of life insurance policies or their liquidation values become owned free and clear by the investor.

The instant inventive method does burden an otherwise traditional investment property purchase with the additional capital investment of the purchase price of the portfolio of life insurance policies, and the method entails a cash flow burden in the form of insurance policy premium payments. Yet, these disadvantages are accommodated and counter-balanced by the actuarial certainty of the deaths of the insured and the policies' contractually established death benefits. Financial time value adjusted margins existing between typical life settlement proceeds received by life insurance policy owners and the defined death benefits under their policies allow actuarially analyzed portfolios including assignments of those policies to be advantageously bundled with the targeted investment properties according to the methods described above, and the margins and bundling practice more than compensates for the noted disadvantages. Enhanced lender security, improved access to lender financing, and reduced cash flow demands upon the investor during the loan term tend to facilitate investor property acquisitions where more traditional financing modes would fail.

The above-described aspects and other aspects of the invention may be implemented with computer hardware, software, or a combination thereof. For example, an embodiment of the invention is a computer program stored on a computer-readable medium for directing operation of a computer system to assist with the purchase and finance of an income-producing property investment. The computer program may comprise a code segment for receiving data related to the income-producing property; a code segment on receiving data related to a plurality of life insurance policies; and a code segment for identifying, at least partially based on the data, life insurance policies that may be purchased and associated with the income-producing property to enhance an investment metric of the income-producing property.

Another embodiment of the invention is a computer-implemented method for purchasing an income-producing property. The method may comprise receiving in a computer system data related to the income-producing property; and analyzing the data with the computer system to identify life insurance policies that may be purchased and associated with the income-producing property to enhance an investment metric of the income-producing property.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram illustrating persons and/or entities that may implement aspects of an embodiment of the invention and the relationships between these persons and/or entities.

FIG. 2 is a schematic diagram illustrating persons and/or entities that may implement aspects of another embodiment of the invention and the relationships between these persons and/or entities.

FIG. 3 is a schematic diagram of computer and communication equipment that may be used to implement aspects of the invention.

FIG. 4 is a flow diagram depicting steps in a computer-implemented method of the invention and/or code segments of a computer program for implementing portions of the method.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

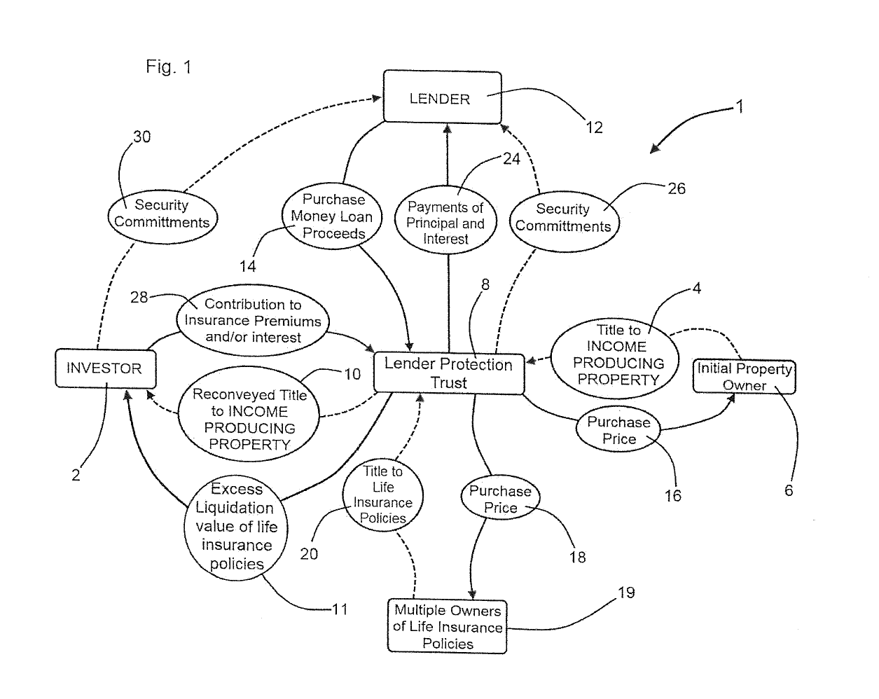

With reference to FIG. 1, a method 1 of creating and managing an income-producing property investment will now be described. Computer systems and computer programs for implementing the method 1 and other methods are described in more detail below.

The following are variables that may be considered in various embodiments of the method and other aspects of the invention:
Insured's Life Expectancy: The remaining life expectancy (LE) of an insured person, in years and/or months, as defined by a life expectancy report or certificate and issued by a life settlement actuarial underwriter.
The Annual Premium Costs of the Life Insurance Policy: The costs to maintain a life insurance policy. Some policies have fixed annual premium costs for a set number of years, then the premiums may escalate. Other policies have variable premium costs that change each year as the insured ages, and some policies are fixed for the life of the policy. The cost of most policies vary as the person ages.
The Cost of the Policies: The purchase price, or costs to acquire, life insurance policies. Policies can be bought individually direct from the insured, by a licensed settlement provider or from a life settlement broker. The prices for policies can range from 1% (distressed policies where the policy is about to lapse) to 40 to 50% for low life expectancies. Policies in the “tertiary market” are usually bundled together in portfolios with $100,000,000 being a small portfolio and $300,000,000 to $500,000,000 being more the average. Aged distressed portfolios often offer the most attractive bargains.
The Credit Rating of the Insurer that issued the policy and pays the benefits: The credit rating can range from D to AAA. More of the policies acquired with the present invention will be A− to AAA, few may be B− to A−.
The Face Value of the Policy: The amount of money a policy pays out upon the death of the insured. Most life settlements are between $250,000 and $10,000,000 with the average being $3,000,000. Jumbo policies are policies above $10,000,000. The present invention can use policies under $250,000, which are unattractive to many investors due to their low face value and accordingly often less expensive to purchase. As explained below, the methods of the present invention attempt to find the right combination of cumulative face values for a given income-producing property.
The Age of the Insured: Although the life expectancies (LEs) are an important variable, at times the LE can be deceiving, and the age alone can be used to determine a particular policy value. For example, embodiments of the method may find LEs of 6 yrs or less, but only find insured over the age of 85.
The number of policies to be included in the Trust for the Project(s): The smaller the target investment, the larger the desired number of individual policies and thus the smaller amount of policy face value desired to be used in trust. Since the LEs are based off of 1,000 lives, a portfolio of 1,000 lives is the most desired size.
The amount of money the investor invests to acquire the Life Settlements: The investor may pay 100% of the costs to acquire the life settlements or may have the entire policy costs financed as explained below.
The amount of premium reserves to be held: The lender, or the investor, may wish to strengthen the portfolio by placing in reserves an amount ranging from 6 months of the life insurance premiums to 4 years of premium reserves, depending on the cash flow predictability and volume of cash being generated by the income-producing property. One year of premium reserves should be the normal and would probably be released after the loan-to-value drops below a predetermined percentage point.
The percentage of each policy benefits to be applied to the principal repayment: 100% of the policy benefits may be applied towards principal repayment for a set number of years, or a lower percentage may be devoted towards the principal repayment, with the option of percentage varying according the loan-to-value ratio.
Additional Life Settlement acquisition costs: Cost for due diligence, legal fees, trust setup fees, policy servicing and other related acquisition costs.
Pro-rata share of a pooled portfolio: A specific portfolio targeting an asset to be acquired may be part of a larger pool of policies in a larger portfolio in order to reduce the risks associated with smaller portfolios. In this case, the percentage or pro-rata share belonging to the given investors interest will be assigned to the larger portfolio and will be expressed by showing just the investors' given share of annual premium payments, other policy acquisition costs, reserves to be held and the distribution of policy benefits.
The Acquisition Price for the Asset: The hard and soft costs needed to acquire an income-producing property or properties.
The Net Operating Income (NOD: The annual, quarterly and monthly net cash produced by any given income-producing property or other asset after all regular operating expenses have been paid.
The Annual Loan Repayment Costs: The costs to pay the loan payments. The acquisition of an income-producing property and/or life insurance policies may be an all cash equity contribution or investor may obtain a loan. Such loan note may be an interest only note, or an amortized loan.
The Interest Rate: The rate of interest charged by the lender or seller for the principal sum used to acquire a property and/or acquire the life settlements.
The number of years the loan is to be amortized: The loan could be interest only for a predetermined number of years and then be amortized for an additional period, or it could be all amortized, or all interest only.
The second mortgage or equity participation: The investment may include mezzanine financing, a second mortgage or an equity injection in order to help leverage investors' investment and generate better returns and preserve their available cash on hand.
The amount of income from liquidating the targeted acquisition asset: This variable will show enhanced returns either from selling off the asset at the end of the project or by showing if liquidating the asset at some earlier point during the project could be more desirable.

Embodiments of the invention consider some or all of the above-described variables when bundling or otherwise associating a number of life insurance policies, or one or more portfolios of policies, with one or more income-producing properties to be purchased as described below.

Returning to FIG. 1, the method 1 may begin when an investor 2 identifies as an acquisition target an item or items of income-producing property 4. The income-producing property 4 may comprise commercial office buildings, retail centers, industrial property, apartment building, a house, a hotel, a multifamily property, a warehouse, a church, a condominium, a senior care facility, a resort, a commercial property, a public infrastructure project, a public use facility, a farm, a land development, a marine vessel, an aircraft, a tool, a machine, a household furnishing, an office furnishing, a retail fixture, ocean going vessels, land vessels or any other income-producing property. Purchase negotiations proceed with the current owner 6 of the income-producing property 4, such negotiations preferably establishing a first contract purchase price 16 for the acquisition of the property 4.

In some embodiments of the invention, a trust such as a lender protection trust 8 may be established. The party negotiating the first purchase price 16 may comprise either the investor 2 or the trust 8 acting by and through its trustee. Such trustee of the trust 8 and the investor 2 may constitute one and the same individual or business entity. Alternatively, the trust 8 may function under the auspices of a facilitating company which operates as trustee in manner of a title company escrow department or a bank trust department. In one mode of performance of the method 1, title to the income-producing property 4 is initially held as a part of the corpus of the trust 8, and income from such property flows into the trust 8 as a first income stream.

At least a part of the first purchase price 16 negotiated for the acquisition of the income-producing property 4 may be funded with a portion of purchase money loan proceeds 14 which are borrowed from a lender 12 who is knowledgeable of the method 1. The purchase money loan proceeds 14 may pass through the trust 8 to fund payment of the first purchase price 16. Also, the trust 8 may be positioned as the lender's principal borrower. Alternatively, the investor 2 may be established as the lender's principal borrower. Where the trust 8 is recognized as the principal borrower of the lender 12, security commitments 30 granted by the investor 2 unto the lender 12 preferably include the investor's personal guaranty. In other embodiments, no loans are secured. Instead, the property or properties are purchased with cash. In still other embodiments, the purchase price may be funded with equity contributions.

A portfolio of life insurance policies formerly owned by multiple life insurance policy owners 19 are then identified and selected. The life insurance policies may be term, universal, whole life, viaticals, or any other type of policies. As with the first purchase 16 of the income-producing property 4, a second portion of the purchase money loan proceeds 14 may be advanced to fund all or a major portion of a second purchase price 18 by which the life insurance policy portfolio 19 is acquired. Or, the life insurance policies may be purchased without a loan. The corpus of the trust 8 preferably additionally includes title 20 to and ownership of the portfolio of life insurance policies.

The payment terms of the purchase money loan which generates loan proceeds 14 are negotiated, tailored, and fitted to be augmented and served by a forecasted course of payment of death benefits from the portfolio of life insurance policies 19,20. Such forecast is preferably derived from actuarial and financial analyses specifically directed to the portfolio of life insurance policies 19,20 so that the loan payment terms and benefits payment performance of the life insurance portfolio are closely coordinated. Preferably, the maturity date of the purchase money loan is established to postdate a projected time at which a sufficient level of death benefits from the life insurance policy portfolio is expected to have been realized.

Over the life of the purchase money loan, sporadically received death benefits may be deposited within and may magnify the corpus of the lender protection trust. This progressively lessens the lender's risk of loss through loan default. Such mode of accumulating the life insurance policy death benefits acts as a positive inducement to the lender to enter into the loan transaction, and may result in lowering of the interest rate charged to the investor 2. Alternatively, such death benefits which predate the term of the loan may be immediately remitted to the lender 12 in reduction of the loan's principal balance. The investor 2 experiences a progressive lessening of its loan interest expenses over the life of the loan, advantageously lessening cash flow demands burdening the investor 2 and the lender protection trust 8.

A portion of the security commitments 26 extending from the trust 8 to the lender 12 preferably include trust beneficiary terms establishing that during the life of the loan the lender constitutes the sole and primary beneficiary under the trust. Additional security commitments 26 extended to the lender 12 may comprise a mortgage or security interest in the income-producing property 4, a deed of trust to the income-producing property 4, a security interest in the portfolio of life insurance policies 19,20 and, where the investor 2 is named as the lender's principal borrower, the loan payment guaranty of the trust 8.

Duties of the trust 8 preferably include compiling and establishing the portfolio of life insurance policies 19,20 and coordinating the forecasted death benefits from such portfolio with the negotiated terms of the purchase money loan 14. The trust 8 may also negotiate and contract for the acquisition of the income-producing property 4 and may act as a conduit for payment of the purchase money loan proceeds 14 advanced therefor. Additionally, the trust 8 may have ongoing responsibilities for remitting scheduled loan payments 24 to the lender, keeping track of insureds under the portfolio 19,20, processing death benefits claims as the insureds die, maintaining the life insurance policy portfolio 19,20 through timely premium payments, and maintaining and managing the income-producing property 4, along with its first income stream.

The contributions to insurance premiums and interest 28 which are made by the investor 2 are preferably set at a level markedly less than that which would otherwise be experienced by the investor in conventional lender financed acquisition of the same investment property 4. The ability of the present method to satisfy the lender 12 with “interest only” payments prior to loan maturity is a factor reducing the investor's cash flow burden.

Upon maturation of the purchase money loan 14, life insurance death benefits accumulated within the trust 8 are typically sufficient to retire the loan by paying off its principal balance. Alternatively, where death benefits are progressively paid to the lender over the life of the loan, the principal balance of the loan will typically have been reduced to zero at or near the loan's maturity date. In the event that total death benefits realized as of loan maturity are insufficient to retire the purchase money loan, a portion of the remaining portfolio of life insurance policies 19,20 may be liquidated in order to retire the purchase money loan 14 without resort to other resources. Or, the investor may refinance the loan or utilize other resources to pay such insufficiency. According to the method, the liquidation value remaining within the life insurance policy portfolio as of loan maturity may equal or exceed any loan balance which is not covered by realized death benefits. The portfolio devaluating effect of any unforecasted longevity of the insureds named in the portfolio necessarily diminishes over the life of the loan, such diminishment advantageously guaranteeing that a portfolio value sufficient to pay off the loan at maturity will exist.

Referring again to FIG. 1, at the termination of performance of the inventive method, releases and satisfactions of the security commitments 26 are granted by the lender, and the trust 8 then conveys the initial income-producing property 4 as reconveyed title 10 to the investor 2.

Any excess liquidation value 11 of the portfolio of life insurance policies 19,20 is preferably additionally paid to the investor 2 at the termination of performance of the method, the trust 8 having a final duty and responsibility of executing such portfolio liquidation. Alternatively, the trust may convey the portfolio in kind to the investor, or the trust may remain in existence to serve as an ongoing portfolio manager.

At the termination of performance of steps of the instant inventive method, the trust is typically divested of all property, and all debts owed to the lender 12 are satisfied. Accordingly at that point, the trust 8 may be terminated if desired.

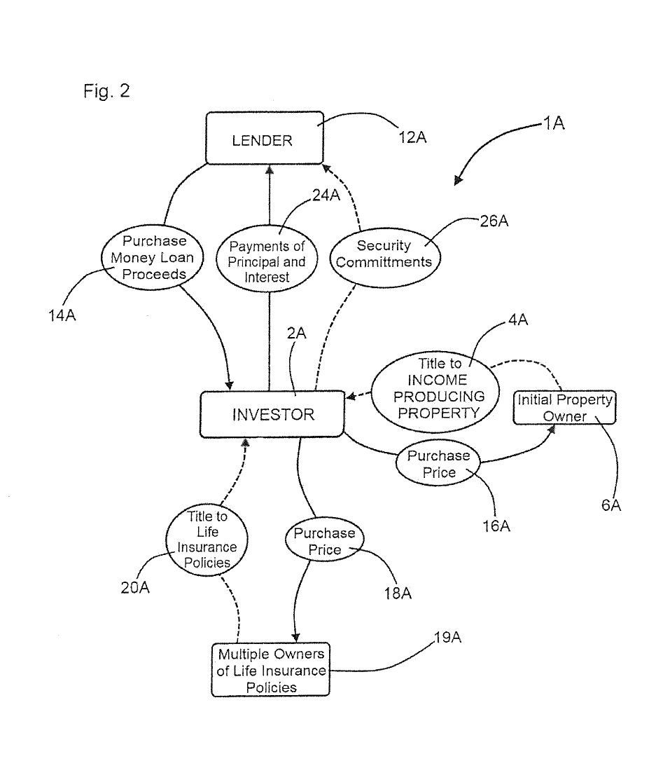

Referring to FIG. 2, a schematic diagram of a suitable, though less desirable mode of performance of the instant inventive method is referred to generally by Reference Arrow A. Each reference numeral having the suffix “A” denotes a method step performed substantially identically with similarly numbered method steps represented in FIG. 1. In the method of FIG. 2, all of the activities of the trust 8 of FIG. 1 are performed by the investor 2A, and the fiduciary duties owed by the trust 8 to the lender 12 of FIG. 1 are replaced and are imposed as a matter of contract as direct duties of the investor 2A owed to the lender 12A. While all of the advantages of tailoring of the portfolio of life insurance policies 19A,20A to the terms of the purchase money loan 14A are present within the alternative mode of performance of FIG. 2, such mode is less desirable than the mode of FIG. 1 because the mode of FIG. 2 provides a less favorable repository for life insurance death benefits which are realized during the term of the loan. By establishing a trust 8, the lender 12 is not required to experience partial loan prepayments upon each receipt of a death benefit during the life of the loan since such benefits may be held in trust for the benefit of the lender. Accordingly, by utilizing the trust 8, the lender 12 may advantageously opt to realize its contracted for loan interest rate over the life of the loan while the lender's risk of loss through default progressively diminishes as paid death benefits periodically expand the liquid holdings of the trust 8.

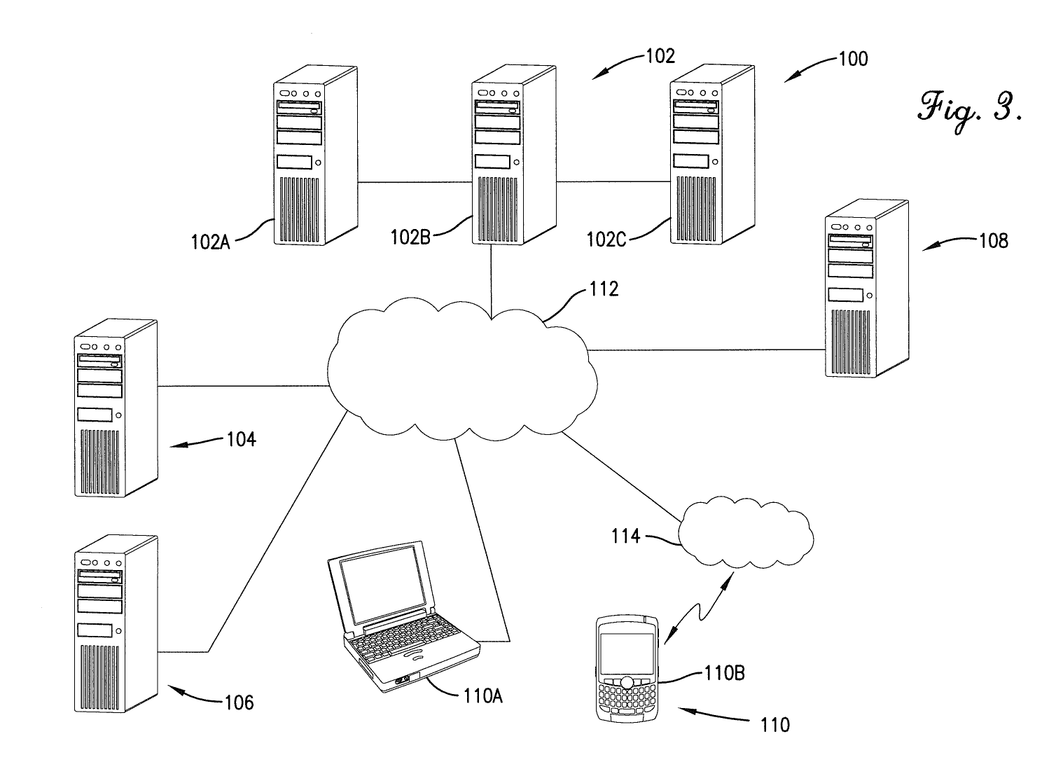

Aspects of the above-described methods 1 and 1A and other embodiments and aspects of the invention can be implemented with computer hardware, software, firmware, or a combination thereof. In one embodiment, aspects of the invention may be at least partially implemented with a system of computer and communications equipment broadly referred to by the numeral 100 in FIG. 3. An embodiment of the computer and communications equipment 100 includes a computer system 102, computer systems 104, 106, a computer system 108, one or more personal electronic devices 110, a communications network 112, and a wireless telecommunications network 114. The components of the computer and communication equipment 10 illustrated and described herein are merely examples of equipment that may be used to implement embodiments of the present invention and may be replaced with other equipment without departing from the scope of the present invention.

The computer system 102 may be operated by or for an entity that facilitates the investment methods of the present invention. For example, the computer system 102 may be operated by or for a life insurance, life settlement, or viatical policy broker, consultant, or provider; a trust company; an investment advisor; or even a bank or other lender. The computer system 102 stores or accesses data and other information that may be used by a facilitator of the investment methods and may implement one or more computer programs for performing some of the functions described herein. The computer system 102 may also provide a web-based portal that can be accessed by users of the other devices in the system 100.

Embodiments of the computer system 102 may include one or more servers running Windows; LAMP (Linux, Apache HTTP server, MySQL, and PHP/Perl/Python); Java; AJAX; NT; Novel Netware; Unix; or any other software system. The computer system 102 includes or has access to computer memory and other hardware and software for receiving, storing, accessing, and transmitting information as described below. The computer system 102 may also include conventional web hosting operating software, searching algorithms, and an Internet connection, and may be assigned a URL and corresponding domain name so that it can be accessed via the Internet in a conventional manner.

The computer system 102 may comprise several servers as illustrated, including for example, a web server, a database server, an application server, and/or an FTP server. The number and type of servers in the computer system 102 is a matter of design choice and may depend on the number of investments managed by the facilitator and/or the number of requests and other queries received by the computer system 102. Thus, the invention is not limited to the specific servers and other equipment described and illustrated herein.

The computer systems 104, 106 may be operated by one or more sources of life insurance policy data and information. For example, the systems 104, 106 may be operated by a life settlement broker, a life insurance provider or agent, or even the individual owners of life insurance policies. Each computer system 104, 106 may comprise any number of servers or other equipment that provides life insurance data to and receives data from the computer system 102 via the communications network 112 or any other network. As described above and below, the life insurance data may include the life expectancies for the insureds, the face value of the policies, the premiums for the policies, or data related to any of the other variables set forth above. Although two computer systems 104, 106 are shown in FIG. 2, it is understood that any number of such systems may interact with the computer system 102.

The computer system 108 may be operated by banks, credit unions, savings and loans, or other lenders. The lender can even be the seller of the income-producing property or properties. An exemplary computer system 108 may include any number of servers or other computers. In some embodiments of the invention, the computer system 108 provides financial data to and receives data from the computer system 102 via the communications network 112 or another network. For example, as described above and below, the computer system 108 may provide the computer system 102 data for loans used by the investor to purchase income-producing properties and/or life insurance policies.

The personal electronic devices 110 may be any devices used by investors and others to access the computer system 102, the computer systems 102, 106 or the computer system 108 via the communications network 22, the wireless network 24, and/or any other network. The personal electronic devices 110 may be mobile phones or similar devices that can make and receive wireless communications such as phone calls, SMS texts, MMS messages, SMTP messages, etc. via the wireless telecommunication network 24. The portable electronic devices may also include phone-enabled personal digital assistants, phone-enabled MP3 devices, phone-enabled handheld game players, phone-enabled tablet computers, or any other wireless communication devices. In some embodiments, the personal electronic devices are “smart” phones such as those manufactured by Apple®, Blackberry®, or Motorola®. The personal electronic devices 110 may also be desktop computers, laptop computers, tablet computers, handheld gaming devices or other portable personal computers that include mobile phones or other wireless communication devices. Each personal electronic device preferably includes or can access an Internet browser and a conventional Internet connection such as a wireless broadband connection, a modem, DSL converter, or ISDN converter so that it can access the computer system 102 via the communications network 112 or 114.

The communications network 112 is preferably the Internet but may be any other communications network such as a local area network, a wide area network, or an intranet. The wireless network 114 may be any network capable of supporting wireless communications such as the wireless networks operated by AT&T, Verizon, or Sprint. The wireless network 114 may include conventional switching and routing equipment. The communications network 112 and wireless network 114 may also be combined or implemented with several different networks.

Embodiments of the present invention also comprise one or more computer programs stored in or on computer-readable medium residing on or accessible by the computer system 102 or other computer equipment for performing or assisting with some of the functions described above. The computer programs may comprise listings of executable instructions for implementing logical functions in the computer equipment. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

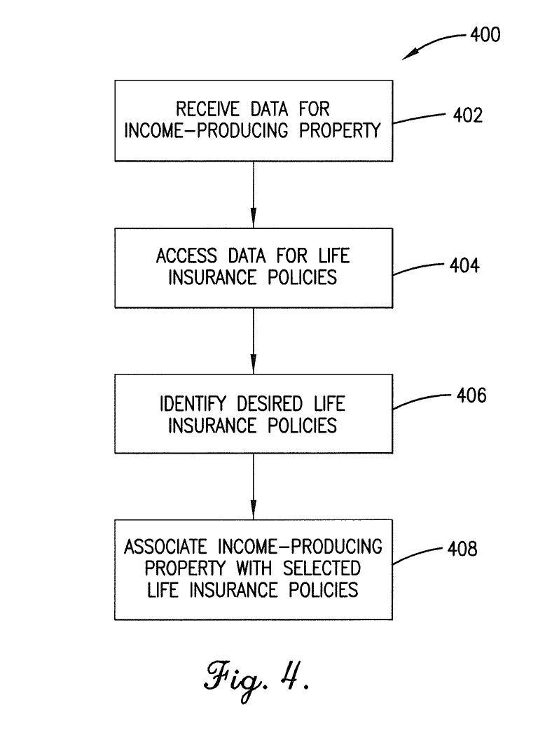

The flow chart of FIG. 4 shows the functionality and operation of exemplary implementations of the present invention in more detail. In this regard, some of the blocks of the flow chart may represent a module segment or portion of code of the computer programs of the present invention. The computer programs may comprise one or more executable instructions for implementing the specified logical function or functions. In some alternative implementations, the functions noted in the various blocks may occur out of the order depicted in FIG. 4. For example, two blocks shown in succession in FIG. 4 may in fact be executed substantially concurrently, or the blocks may sometimes be executed in the reverse order depending upon the functionality involved.

Aspects of the invention may begin when the computer system 102 or other computer equipment receives data for an income-producing property or properties to be purchased as depicted by step 402 in FIG. 4. The data may include the purchased property's purchase price, expenses, income, or other relevant data.

Then, as depicted by step 404, the computer system 102 or other computer equipment may access data for a number of life insurance policies. As mentioned above, such data may come from a variety of sources including the computer systems 104, 106 and may include the life expectancies of the insureds, the premium costs of the policies, the purchase prices of the policies, and the face values of the policies, and/or data related to any of the other variables described above.

The computer system 102 or other computer equipment may then identify life insurance policies, or portfolios of policies, that can be bundled with the income-producing property to increase the investor's rate-of-return, decrease the lender's risk, and/or enhance any other investment metric as depicted in step 406.

The selected life insurance policies are then purchased and associated with the purchased income-producing property as shown in step 408 and as described above. For example, the purchased income-producing properties and life insurance policies may be bundled into a single investment by obtaining a loan or loans that are secured by both the income-producing properties and life insurance policies.

In some embodiments of the invention, step 406 and other steps may be performed with a computer program designed to search for the desired set of life insurance policies that may be pooled together to target the acquisition of any given income-producing property or properties. In beginning a search, an analyst or a consultant must first identify the leading characteristics and/or most desired financial outcomes of a given investment as identified by each individual investor and/or by the needs of the anticipated tangible asset to be acquired. The investment will always have two defining components that serve as the basis of the investment: 1) a portfolio of life insurance policies or viatical settlements; and 2) an income producing asset that generates predictable liquidity.

Once the analyst or other user has worked with the investor to identify their hierarchical investment needs pertaining to their investment, the analyst may assign a ranking numerical value to each variable to be utilized in the program corresponding to their greater or lesser importance. Then, the analyst will set, with the mutual participation of the investor, a list of the most desired numerical expressions of the performance of the investment.

Having accomplished both of the above tasks, the analyst can use the computer program to begin the process of searching for the life insurance policies that match the investor's needs and optimize the investment. In initiating the search, the analysis will first establish a dataset of potential life settlement policies to consider. To do so, the analyst first accesses an input section of the software program that allows the analyst to select parameters for certain investment variables. Then, the analyst may establish and enter parameters for each of the variables and assign each variable a numerical value of importance based on the investor's anticipated needs.

The analyst may then access a database of life settlement or viatical policies contained within or accessible by the program. The computer program then runs a hierarchical filter on the database of policies and sorts the policies according to those policies which contain the most desired characteristics. The program then displays those policies in the order of most important variables first and those with the least desired characteristics last. The analyst next selects a predetermined group of the leading variables established as the most important variables, in order to establish a database of policies which the analyst will save as the “given projects name” policy dataset.

The next steps involve analyzing data about the income-producing property or properties being purchased. To do so, the analyst or someone else may enter data into the computer program to establish the investment profile of the target tangible asset. Such profile data may includes the investment property's: acquisition price, anticipated annual cash revenues, any possible financing costs or other predetermined factors, and operating expenses. This profile data is then saved as the “given project name” investment profile.

The analyst then sets the parameters of the level of performance desired from the investment trust or investment contractual obligation, according to the analysts' desired measures of performance. Such performance information may include comparisons of the methods of the present invention with traditional financing, including a comparison of the annual rates of return, internal rates of return, amounts of annual cash flows, or other predetermined measures of desired performance.

The next steps involve analyzing the database of candidate life insurance policies to determine which to include in the investment trust. To do so, the analyst may run a component of the program which will search the “given projects name” dataset, according to the performance standards set in the “given project name” investment profile; and list the policies which performed the best under each aspect of the performance parameters that were established for the investment profile. The program may then search the best performing policies and separate them according to each of the performance measures.

The analyst may next input a range of the target portfolio size, which will then select the life insurance polices which have a cumulative sum closest to the target portfolio size with the greatest performance desired. The range can then be expanded to see if expansion increases any desired level of performance.

At this point of the searching process, the analyst has determined the best performing life insurance policies that feature the most desirable characteristics. However, in order to ascertain if a desired level of performance could be significantly enhanced, the analyst may decide to expand the initial group of life insurance policies selected that contained the most important variables, to include one or more other variables not initially selected. If any such policy(s) are determined to significantly enhance the investment performance, than they may be included in any performance set.

The next steps establish the final policies to include in the investment trust. From the list of policies comprising the portfolio of policies that were closest in cumulative value to the target asset acquisition size in the “given projects name” data set, the analyst will select any policies that appeared in all of the performance level reports. If all the policies appeared in each of the performance level reports, the analyst may select the most desired policies to be included in the given portfolio. If the cumulative sum of the most common policies listed in each set of the performance measure is unacceptable in size, then the analyst will run a component of the program to search and find any remaining policies listed in the “final” data set that reaches the desired cumulative size and appears most often in the various performance levels measured.

With various search results in hand, the analyst will be prepared to present the most desired portfolio of life insurance policies with the most desired characteristics chosen by the investor. In addition, optional portfolio performances that contained other less desirable characteristics, but that exceed the performance of portfolio selected with the most desired characteristics, could be considered for discussion purposes with the investor.

The following are three examples of fictitious investments that may be created and financed using principles of the present invention.

### Example 1

An investor is contemplating the acquisition of a $10M distressed apartment complex called Lincoln Heights. The investor has determined that it may take two to three years to achieve normal operating vacancy rates given the need for extensive remodeling and current low occupancy rates. Additionally, the lender has required a 10 year balloon payment. At normal occupancy, the complex will generate a very strong cash flow, so the investor is concerned about high insurance policy premium payments the first few years, and less so thereafter.

Therefore, in consultation with the investor, the analyst has set up the software to find insurance policies with the following most important variables:
LEs of less than ten years.
Low annual premium payments for the first three years.
Low acquisition costs.
Credit rating of the insurer of no less than A−.
A face value of less than $2,000,000.

The software then searches a database containing data for thousands of policies and generates a list of approximately 100 policies that meet the above criteria. The software then saves data for the policies in a file labeled as the “Lincoln Heights Policy Dataset”. The analyst then enters profile data for the target investment and saves such profile as the “Lincoln Heights Investment Profile”. The analyst then establishes a set of performance standards the investment will need to achieve, such as follows: 1) total annual premium costs not to exceed xyz amount for the first three years; 2) IRR greater than 8%; and 3) total costs of the investment to be less than $6,000,000 compared to if the project had been financed with traditional financing.

Upon executing a search of the Lincoln Heights Dataset based on the performance needs of the Lincoln Heights Investment profile, the analyst tells the software program to generate three separate reports that list those policies that cumulatively equate to at least $10,000,000, but no more than $10,500,000. With such report generated, the analyst sees that there are six policies listed in each of the three reports that total $8,000,000 and so selects those policies to be included in the final trust. Still needing an additional $2,000,000 in life settlements, the analyst sees four additional policies that total $2,000,000 and thus selects those policies as the final policies to include. Or, the analyst tells the program to go back to the original database of policies to find more policies to add to the Lincoln Heights Dataset that have an insurer credit rating of more than a B credit rating and finds that those new policies out-perform the last $2M of policies significantly, and thus presents those additional policies for consideration to the client.

Once the decision is made regarding which insurance policies to include in the investment trust and all due diligence has been performed, the apartment building and the insurance policies are purchased, possibly with one or more loans. Then, both sets of assets are placed in a trust, or a contractual obligation, which directs cash revenues generated from the operation of the apartment building to pay the annual premium costs of the life insurance settlements. In turn, as life insurance settlement benefits mature, a predetermined percentage of such benefits are directed to repay any loan principal repayments, if any. Then, over the preceding years, as the policies mature, the loan principle balance is repaid in full and the investor is able to operate the property unencumbered by any acquisition debt.

### Example 2

An investor has located a stable income producing shopping center called Liberty Center, with a purchase price of $80,000,000. The property has strong cash flows, so the client has decided to secure a government guaranteed loan with a low interest rate financed over 30 years.

In consultation with the investor, the analyst has determined that: 1) the investor's primary concern is the accuracy of the insurance policy LEs; 2) the investor highly values positive cash flow; 3) longer LEs are not a concern for the investor; 4) the investor understands the credit rating measurements of the insurers, and is not concerned about taking policies with a B rating; 5) the investor is generally looking to get the best return for his combined life settlement and real estate investment.

The analyst therefore instructs the software to find those insurance policies that will have the following most important variables: 1) the lowest acquisition costs; 2) the lowest LEs; 3) the lowest average annual premium payments; 4) policies that average, within the total portfolio, at least a B insurers rating; and 5) policies with a cumulative face value of least $80,000,000, but not more than $80,500,000.

The software then searches a database containing thousands of policies and generates a list of approximately 350 policies that meet the above criteria. The analyst then saves data for the policies in a file labeled “Liberty Center Policy Dataset”.

The analyst then enters in profile data for the target income-producing property investment and saves such profile as the “Liberty Center Investment Profile”. The analyst then establishes the performance standards of the investment by instructing the program to find those policies that cumulatively have the highest IRR.

Upon executing a search of the Liberty Center Dataset, the program generates a report that lists 15 life insurance policies with a cumulative sum of $80,0000,000 with an average of A− credit rating for all the policies' insurers, and thus selects those policies for the investor.

### Example 2

### Sub-Part A

With the investor's larger concern of the LEs still unaddressed, the mutual decision is made to place the Liberty Center portfolio in a larger investment trust of $400,000,000. With $80,000,000 of policies being placed in the trust, the investor's ownership share of the trust is 20%. Within that trust, the Liberty Center investor will pay his pro rata share of 20% of the total annual premium costs and 20% of the total acquisition costs for the life insurance policies. The acquisition of all of the $400,000,000 life insurance policies would occur at one time, and all of the policies would go then go into the larger trust.

As long as cash is obligated from the operation of the income-producing property assets being purchased, the ownership of the income-producing properties may or may not be included in the trust. When liquidity events occur, the Liberty Center portion of the trust will receive the pro-rata share of the benefits equal to the amount of Liberty Centers' ownership, with a predetermined percentage going to the principal repayment.

### Example 2

### Sub-Part B

In an alternate embodiment of example #2, instead of the analyst and investor selecting policies they most desire to be included in the larger trust, the analyst may compile a list of policies that simply have the lowest price, LEs, premium costs and other best desired variables, and assembles them in a portfolio. From there, each investor will select a desired percentage of ownership, and the analyst will demonstrate how their project preforms with the predetermined percentage of ownership. Such demonstration would also highlight the various stresses of LE fluctuation and diminishing income scenarios.

### Example 3

A group of investment properties (labeled the Dockum Properties) comprising several retail and office buildings has been offered for sale on the open market by a lender who took the properties back through a foreclosure action. After 6 months, the properties have not sold, since no buyers have been willing to offer the desired asking price of $30,000,000. However, an offer is accepted when a buyer offers the seller the following: $45,000,000 in face value of life settlements, along with placing the policies in a trust with the seller as the head trustee or co-trustee, and dedicating the cash flow from the assets to the payments of the life insurance settlement premiums. As the policies mature, the seller receives the proceeds. Once the seller receives the balance of the contract price of $45,000,000, the seller's interest is dissolved from the trust and the buyer owns the property free and clear. The seller may, or may not, have charged any interest on all or a portion of the principal carried for the buyer, but in the end the seller has received a price it deemed acceptable, and the buyer has purchased the properties for significantly less than the desired $30,000,000 asking price.

In structuring the exemplary transactions described above, the software was used to analyze the profitability of the transactions from both the buy-side and sell-side transactions. The software also showed the estimated rate of returns and cost savings perspective for the buyer and showed the value of additional capital being gained according to estimated dates of policies maturation. The software also showed how variance in certain parameters affected the overall profitability of the investment.

Certain investment principles or criteria apply to all of the above described examples and other manifestations of the present invention, including:
The most desired number of life insurance policies to be included in a portfolio is 1,000 lives. To that extent, the more lives in a portfolio the greater the mitigating risk of insureds living past the estimated LEs.
No one insurance policy in excess of 10% of the total value of the insurance policy portfolio should be used in that portfolio.
All policies have a weighted value where necessary. For example, the LE and credit rating of the insurer have more or less value depending on the size of the policies in relationship to the other policies contained within a given portfolio.
If investors choose to include their portfolios in a larger trust, most investors will pick the lowest priced policies, with the lowest premiums, with the lowest LEs.

The computer programs of the present invention may also analyze the performance of the life settlements and the income-producing property or properties based on the variables described above. This performance may be demonstrated by reports that show various rates of returns, including IRR, ARR, yields and other various desired measures of estimated rates of returns, profitability and levels of risk(s).

The reports may also display the total and itemized initial, annual, and final costs of the income-producing property and life insurance policies and additionally, or optionally, will contrast such costs with traditional financing method(s) in order to demonstrate the savings or additional costs of using the present invention. Such contrasting displays may list:
The total project costs paid over the life of a project for interest, life insurance premiums, equity contributions, finance fees, closing fees and other acquisition costs, versus interest, equity contributions, finance fees, closing fees and other acquisition costs of traditional methods of financing.
The total amount of interest paid for any and/or all principle used in financing the project with the present invention versus traditional financing interest costs.
The total amount of annual payments made over the estimated project life with the present invention verses total amount of annual payments made with traditional financing.
The total amount of savings, or additional costs, with the annual payments of the present invention versus traditional financing annual payments.
The revised total project costs paid, with the total amount of savings or additional costs factored in the total project costs.
The percentages of difference for all the above.

The reports may also show the performance of the income-producing properties and life insurance policies under certain stress conditions, such as: 1) varying the LEs by a given percentage to show what happens if the insureds live longer than expected; or 2) devaluing the target acquisition asset by a given percentage, which will show the various results of diminished NOI and future diminished cash value if the asset were to be liquidated.

The reports may also monitor the actual performance of the investment over time, as a project matures and actual numbers are entered in to the program either monthly, quarterly or annually. Actual numbers may also be entered at the end of an accounting period or in real time over a cloud based component or into a single station component.

Examples of some of the above-described reports are below.

The above-described embodiments and other embodiments of the invention provide numerous advantages over prior art methods of acquiring and financing income-producing properties. For example, the above-described software demonstrates the advantages of welding life settlements to income producing assets versus prior art methods of acquiring income-producing properties.

The software also has the ability to stress test the performance of an investment strategy by showing possible future devaluing of the purchased assets and/or the cash flow generated by the assets and by showing possible variances of the maturation of all, or a few of the settlement benefits.

The software also offers investment clients a unique perspective in demonstrating the various cost saving advantages of using the investment strategies compared to traditional methods of financing assets.

The software also offers clients the ability to search and find a portfolio of life insurance policies that meet certain needs or match the desired levels of performance and risk expressed by any given client based on over 20 different variables that define the life settlement portfolio's characteristics and tangible asset's profile.

The software also has the ability to assist in the grouping of smaller portfolios of investments into a larger investment trust by showing all owners and managers of the larger investment trust estimated performance of the trust, all initial costs and future costs, and the how the settlement benefits are to be distributed, as well as to whom they are to be sent.

The software also has the ability to demonstrate to an investor the financial benefits and risks of trading assets on both the buy-side and sell side of any proposed trade of life settlements for tangible asset(s).

The software also has the ability to show up-to-date and historical performances of an investment as it is operating and maturing over the subsequent years after purchase and provides projections of future profitability and investment performance.

The software also has the ability to allow multiple users to access the software with cloud base computing, as well as point of use access through individual personal computers.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A computer program stored on a computer-readable medium for directing operation of a computer system to assist with purchasing an income-producing property, the computer program comprising:
a code segment for receiving data related to the income-producing property;
a code segment for receiving data related to a plurality of life insurance policies; and
a code segment for identifying, at least partially based on the data related to the income-producing property and the data related to the life insurance policies, life insurance policies that may be purchased and associated with the income-producing property to enhance an investment metric of the income-producing property.

2. The computer program as set forth in claim 1, further comprising:
a code segment for receiving data related to a loan or equity contribution that may be acquired from a lender or investor to purchase the income-producing property and/or the life insurance policies.

3. The computer program as set forth in claim 2, wherein the code segment for identifying life insurance policies identifies life insurance policies that are actuarially matched with a term of the loan so that the loan's maturity occurs on or after a date that forecasted cumulative death benefits produced by the life insurance policies exceed the loan's principal balance.

4. The computer program as set forth in claim 1, wherein the income-producing property is an office building, a retail center, an industrial property, an apartment building, a house, a hotel, a multifamily property, a warehouse, a church, a condominium, a senior care facility, a resort, a commercial property, a public infrastructure project, a public use facility, a farm, a land development, a marine vessel, an aircraft, a tool, a machine, a household furnishing, an office furnishing, a retail fixture, or a land vessel.

5. The computer program as set forth in claim 1, wherein the data related to the income-producing property includes data representative of the purchase price of the income-producing property, income received from the income-producing property, and/or expenses for the income-producing property.

6. The computer program as set forth in claim 2, wherein the investment metric is a rate of return for the income-producing property, a cost reduction for the income-producing property, a loan-to-value ratio for a loan secured to purchase the income-producing property or the life insurance policies, or a security commitment for the income-producing property or the life insurance policies.

7. The computer program as set forth in claim 2, wherein the code segment for identifying the life insurance policies takes into account: life expectancies of persons insured by the life insurance policies, a term for the loan, premium costs for the life insurance policies, purchase costs for the life insurance policies, a face value of the life insurance policies, and purchase costs for the income-producing property.

8. A computer system for assisting with purchasing an income-producing property, the computer system comprising:
a computing element for receiving data related to the income-producing property and data related to a plurality of life insurance policies; and
a computing element for identifying, at least partially based on the data related to the income-producing property and the data related to the life insurance policies, life insurance policies that may be purchased and associated with the income-producing property to enhance an investment metric of the income-producing property.

9. The computer system as set forth in claim 8, further comprising:
a computing element for receiving data related to a loan or equity contribution that may be acquired from a lender or investor to purchase the income-producing property and/or the life insurance policies.

10. The computer system as set forth in claim 9, wherein the computing element for identifying life insurance policies identifies life insurance policies that are actuarially matched with a term of the loan so that the loan's maturity occurs on or after a date that forecasted cumulative death benefits produced by the life insurance policies exceed the loan's principal balance.

11. The computer system as set forth in claim 8, wherein the income-producing property is an office building, a retail center, an industrial property, an apartment building, a house, a hotel, a multifamily property, a warehouse, a church, a condominium, a senior care facility, a resort, a commercial property, a public infrastructure project, a public use facility, a farm, a land development, a marine vessel, an aircraft, a tool, a machine, a household furnishing, an office furnishing, a retail fixture, or a land vessel.

12. The computer system as set forth in claim 8, wherein the data related to the income-producing property includes data representative of the purchase price of the income-producing property, income received from the income-producing property, and/or expenses for the income-producing property.

13. The computer system as set forth in claim 9, wherein the investment metric is a rate of return for the income-producing property, a cost reduction for the income-producing property, a loan-to-value ratio for the loan, or a security commitment for the income-producing property or the life insurance policies.

14. The computer system as set forth in claim 8, wherein the computing element for identifying the life insurance policies takes into account: life expectancies of persons insured by the life insurance policies, a term for the loan, premium costs for the life insurance policies, purchase costs for the life insurance policies, a face value of the life insurance policies, and purchase costs for the income-producing property.

15. A computer-implemented method for purchasing an income-producing property, the computer-implemented method comprising:
receiving in a computer system data related to the income-producing property and data related to a plurality of life insurance policies; and
analyzing the data related to the income-producing property and the data related to the life insurance policies with the computer system to identify life insurance policies that may be purchased and associated with the income-producing property to enhance an investment metric of the income-producing property.

16. The computer-implemented method as set forth in claim 15, further comprising receiving in the computer system data related to a loan or equity contribution that may be acquired from a lender or investor to purchase the income-producing property and/or the life insurance policies.

17. The computer-implemented method as set forth in claim 16, further comprising identifying life insurance policies that are actuarially matched with a term of the loan so that the loan's maturity occurs on or after a date that forecasted cumulative death benefits produced by the life insurance policies exceed the loan's principal balance.

18. The computer-implemented method as set forth in claim 15, wherein the data related to the income-producing property includes data representative of the purchase price of the income-producing property, income received from the income-producing property, and/or expenses for the income-producing property.

19. The computer-implemented method as set forth in claim 16, wherein the investment metric is a rate of return for the income-producing property, a cost reduction for the income-producing property, the loan-to-value ratio for the loan, or the life insurance policies, or a security commitment for the income-producing property or the life insurance policies.

20. The computer-implemented method as set forth in claim 15, wherein the analyzing step takes into account: life expectancies of persons insured by the life insurance policies, a term for the loan, premium costs for the life insurance policies, purchase costs for the life insurance policies, a face value of the life insurance policies, and purchase costs for the income-producing property.
